(19) United States
(12) Patent Application Publication
(10) Pub. No.: US 2022/0070329 A1
(43) Pub. Date: Mar. 3, 2022

(54) INFORMATION PROCESSING APPARATUS, NON-TRANSITORY COMPUTER READABLE MEDIUM, AND INFORMATION PROCESSING SYSTEM

(71) Applicant: FUJIFILM BUSINESS INNOVATION CORP., Tokyo (JP)

(72) Inventor: Haruhisa HOSHINO, Kanagawa (JP)

(73) Assignee: FUJIFILM BUSINESS INNOVATION CORP., Tokyo (JP)

(21) Appl. No.: 17/178,394

(22) Filed: Feb. 18, 2021

(30) Foreign Application Priority Data
Aug. 28, 2020 (JP) 2020-144462

(51) Int. Cl. H04N 1/32; H04L 9/30

(52) U.S. Cl. CPC H04N 1/32117; H04N 1/32352; H04L 9/30; H04N 1/32272

(57) ABSTRACT

An information processing apparatus includes a processor configured to store a storage range identifier for identification of a range of a location at which image data is stored in a data storing apparatus, and an identifier common to an identifier that is retained by the data storing apparatus, transmit read image data and the identifier to the data storing apparatus, generate a storage position identifier for identification of a position at which the read image data is stored, the storage position identifier being generated by using the storage range identifier and a character string that is generated by an algorithm common to an algorithm in the data storing apparatus, and transmit the generated storage position identifier to a terminal that uses the image data stored at the position that is identified by using the storage position identifier.

### CROSS-REFERENCE TO RELATED APPLICATIONS

This application is based on and claims priority under 35 USC 119 from Japanese Patent Application No. 2020-144462 filed Aug. 28, 2020.

### BACKGROUND

### (i) Technical Field

The present disclosure relates to an information processing apparatus, a non-transitory computer readable medium, and an information processing system.

### (ii) Related Art

Japanese Unexamined Patent Application Publication No. 2017-167660 discloses that image data that represents a scanned image is saved by a server on the Internet, location data that represents a location at which the image data is saved is transmitted to a designated address of an electronic mail, and the image data is accessed from a terminal that receives the electronic mail.

### SUMMARY

Aspects of non-limiting embodiments of the present disclosure relate to inhibiting image data from being leaked to a third person who is not authorized, when the image data stored in a data storing apparatus is used via a communication line.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to store a storage range identifier for identification of a range of a location at which image data is stored in a data storing apparatus, and an identifier common to an identifier that is retained by the data storing apparatus, transmit read image data and the identifier to the data storing apparatus, generate a storage position identifier for identification of a position at which the read image data is stored, the storage position identifier being generated by using the storage range identifier and a character string that is generated by an algorithm common to an algorithm in the data storing apparatus, and transmit the generated storage position identifier to a terminal that uses the image data stored at the position that is identified by using the storage position identifier.

### BRIEF DESCRIPTION OF THE DRAWINGS

An exemplary embodiment of the present disclosure will be described in detail based on the following figures, wherein:

FIG. 1 illustrates an example of the entire configuration of an information processing system;

FIG. 2 illustrates an example of the hardware configuration of a server apparatus;

FIG. 3 illustrates an example of the hardware configuration of an image reading apparatus;

FIG. 4 illustrates an example of a management table;

FIG. 5 illustrates an example of the functional configuration of the server apparatus;

FIG. 6 illustrates an example of the functional configuration of the image reading apparatus;

FIG. 7 is a sequence diagram illustrating an example of the operation of the information processing system;

FIG. 8 is a sequence diagram illustrating an example of the operation of the information processing system;

FIG. 9 is a sequence diagram illustrating an example of the operation of the information processing system;

FIG. 10 is a flowchart illustrating an example of the operation of the server apparatus; and

FIG. 11 is a flowchart illustrating an example of the operation of the image reading apparatus.

### DETAILED DESCRIPTION

### Exemplary Embodiment

### Configuration of Information Processing System

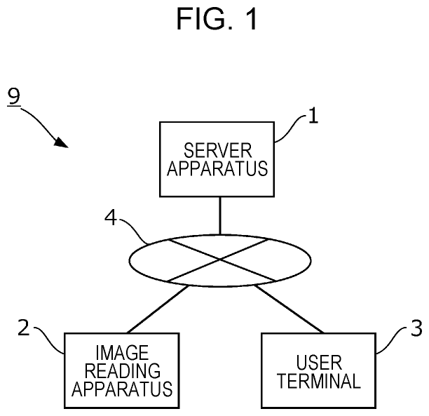

FIG. 1 illustrates an example of the entire configuration of an information processing system 9. The information processing system 9 illustrated in FIG. 1 is used to store image data acquired by scanning an image of, for example, a document in a data storing apparatus via a communication line and to use the image data via the communication line. As illustrated in FIG. 1, the information processing system 9 includes a server apparatus 1, an image reading apparatus 2, a user terminal 3, and a communication line 4.

The server apparatus 1 corresponds to an example of a data storing apparatus according to an exemplary embodiment of the disclosure and is a computer that stores the image data.

The image reading apparatus 2 corresponds to an example of an information processing apparatus or an image reading apparatus according to the exemplary embodiment of the disclosure and is a computer that optically reads an image of a document written on a medium such as paper and that generates image data that represents the image. The image reading apparatus 2 may be a multifunction peripheral into which an image forming apparatus, an image reading apparatus, a facsimile, and a copying machine, for example, are integrated.

The user terminal 3 is an apparatus that corresponds to an example of a terminal according to the exemplary embodiment of the disclosure and is a computer that is operated by a user to, for example, download, browse, edit, and/or save the image data described above. Examples of the user terminal 3 include a personal computer, a smartphone, and a tablet.

The communication line 4 connects the server apparatus 1, the image reading apparatus 2, and the user terminal 3 such that these are capable of communicating with each other. Examples of the communication line 4 may include a local area network (LAN), a wide area network (WAN), the Internet, and any combination thereof. The communication line 4 may include, for example, a public switched telephone network (PSTN) or an integrated services digital network (ISDN).

In the information processing system 9, the number of the server apparatus 1, the number of the image reading apparatus 2, the number of the user terminal 3, and the number of the communication line 4 are not limited to the numbers of those illustrated in FIG. 1. For example, the server apparatus 1 may be configured by a cluster system in which multiple apparatuses share functions.

There is a method in which when the user terminal 3 uses the image data that is read by the image reading apparatus 2, the read image data is attached to an electronic mail and is transmitted to the user terminal 3. However, the data size of data that is attachable to the electronic mail is limited, and the method is not suitable to transmit image data having a large data size. Thus, it is considered that the image reading apparatus 2 retains the read image data for a certain period of time, and an electronic mail with a URL for downloading the image thereof is transmitted to the user terminal 3, for example, within an intranet of an organization. The reason why such a method is used is that even image data having a large data size is allowed to be downloaded by using a mail address, which is easy to designate, and accessing the URL by using, for example, a web browser, and no authentication information such as a user ID and a password is inputted.

In consideration of widespread remote work or work from home in recent years, it is convenient that such configuration is usable not only in a closed network such as the intranet but also in an open network such as the Internet. If the URL is leaked to a third person who is not authorized, however, the third person is able to download the image data, and herein lies a problem about security. Hardware Configuration of Server Apparatus 1

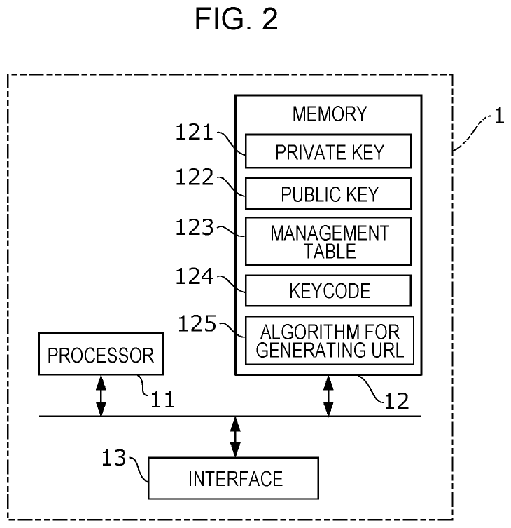

FIG. 2 illustrates an example of the configuration of the server apparatus 1. The server apparatus 1 illustrated in FIG. 2 includes a processor 11, a memory 12, and an interface 13. That is, the server apparatus 1 corresponds to an example of an information processing apparatus that includes a memory and a processor. These components are connected to each other by using, for example, a bus so as to be capable of communicating with each other.

The processor 11 controls the components of the server apparatus 1 by reading and running a program that is stored in the memory 12. An example of the processor 11 is a central processing unit (CPU).

The interface 13 is a communication circuit that connects the server apparatus 1 to the image reading apparatus 2 with a wired cable or wirelessly via the communication line 4 such that these are capable of communicating with each other.

The memory 12 is a storage unit that stores, for example, an operating system, various programs, and data that are read by the processor 11. The memory 12 includes a random access memory (RAM) and a read only memory (ROM). The memory 12 may include, for example, a solid state drive and/or a hard disk drive. The memory 12 stores a private key 121, a public key 122, a management table 123, a keycode 124, and an algorithm 125 for generating a URL.

The server apparatus 1 and the image reading apparatus 2 are prepared for every organization such as a company or a place of business. Thus, the server apparatus 1 and the image reading apparatus 2 store a common keycode as an identifier (an example of an identifier according to the exemplary embodiment of the disclosure) for identification of the organization. An example of the keycode is a character string that includes a predetermined number of characters. In FIG. 1, the single server apparatus 1 and the single image reading apparatus 2 belonging to a single organization are illustrated. In the case where multiple server apparatuses 1 and multiple image reading apparatuses 2 belong to the organization, however, all of the multiple server apparatuses 1 and the multiple image reading apparatuses 2 store the common keycode. That is, the server apparatuses 1 and the image reading apparatuses 2 belonging to the common organization are associated with each other, and image data that is read by the image reading apparatuses 2 is stored in the server apparatuses 1 associated with the image reading apparatuses 2.

A set of the private key and the public key to be stored in the server apparatus 1 are prepared for the organization described above. The private key and the public key conform to, for example, a public key infrastructure (PKI).

The memory 12 stores the image data that is generated by the image reading apparatus 2. The image data is stored in a storage range having a certain size in the memory 12, and the storage range is allotted to every organization. According to the exemplary embodiment, the storage range having a certain size and allotted to every organization is referred to as an image data storage range, and a position at which the image data is stored in the image data storage range is referred to as an image data storage position. The image data storage range and the image data storage position are represented by Uniform Resource Locators (URLs). The URL that represents the image data storage range is a higher-level URL than the URL that represents the image data storage position. The algorithm for generating a URL that the memory 12 stores corresponds to a program for generating the URL that represents the image data storage range and the URL that represents the image data storage position.

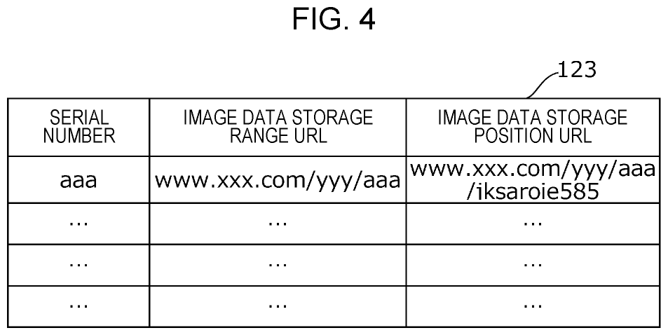

FIG. 4 illustrates an example of the management table 123. The management table 123 illustrated in FIG. 4 includes records each containing: the serial number (an example of an apparatus identifier according to the exemplary embodiment of the disclosure) of the image reading apparatus 2, an image data storage range URL (an example of a storage range identifier according to the exemplary embodiment of the disclosure) that represents a range in which the image data that is generated by the image reading apparatus 2 is stored in the memory 12, and an image data storage position URL (an example of a storage position identifier according to the exemplary embodiment of the disclosure) that represents a position at which the image data that is generated by the image reading apparatus 2 is stored in the memory 12. In the case where the serial number is “aaa” as illustrated by way of example in the figure, the image data storage range URL is “www.xxx.com/yyy/aaa”, which includes a character string corresponding to the serial number at the end. The image data storage position URL is “www.xxx.com/yyy/aaa/jksaroie585”, which includes the image data storage range URL and, for example, a random character string (an example of a character string according to the exemplary embodiment of the disclosure) at the end.

### Hardware Configuration of Image Reading Apparatus 2

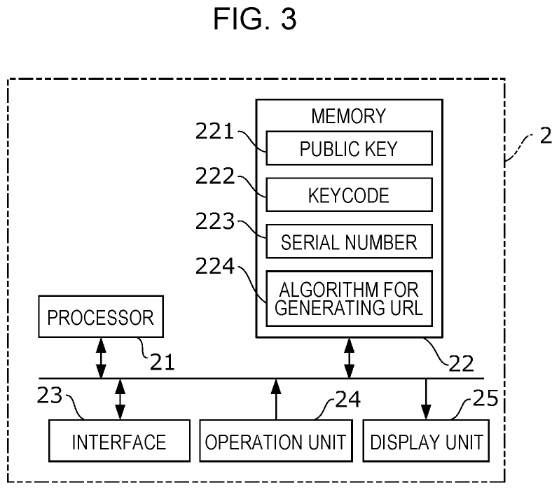

FIG. 3 illustrates an example of the configuration of the image reading apparatus 2. The image reading apparatus 2 illustrated in FIG. 3 includes a processor 21, a memory 22, an interface 23, an operation unit 24, and a display unit 25. These components are connected to each other by using, for example, a bus so as to be capable of communicating with each other.

The processor 21 controls the components of the image reading apparatus 2 by reading and running a program that is stored in the memory 22. An example of the processor 21 is a CPU.

The interface 23 is a communication circuit that connects the image reading apparatus 2 to the server apparatus 1 with a wired cable or wirelessly via the communication line 4 such that these are capable of communicating with each other.

The operation unit 24 includes operators for various instructions, such as an operation button, a keyboard, a touch screen, and a mouse, receives an operation, and transmits a signal in response to the content of the operation to the processor 21.

The display unit 25 includes a display screen such as a liquid-crystal display and displays an image under control of the processor 21. A transparent touch screen of the operation unit 24 may be stacked on the display screen.

The memory 22 is a storage unit that stores, for example, an operating system, various programs, and data that are read by the processor 21. The memory 22 includes a RAM and a ROM. The memory 22 may include, for example, a solid state drive and/or a hard disk drive. The memory 22 stores a public key 221, a keycode 222, a serial number 223, and an algorithm 224 for generating a URL as in the server apparatus 1 described above.

### Functional Configuration of Server Apparatus 1

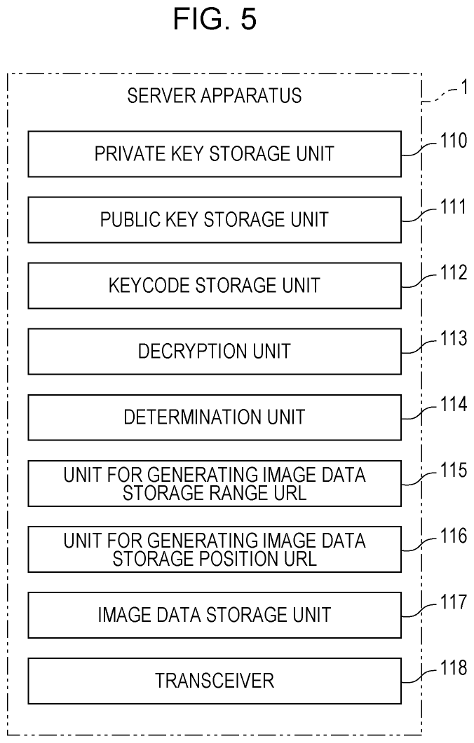

FIG. 5 illustrates an example of the functional configuration of the server apparatus 1. The processor 11 of the server apparatus 1 runs a program that is stored in the memory 12 to function as a private key storage unit 110 that stores the private key, a public key storage unit 111 that stores the public key, a keycode storage unit 112 that stores the keycode, a decryption unit 113 for decryption with the private key described above, a determination unit 114 that makes various determinations described later, a unit 115 for generating the image data storage range URL described above, a unit 116 for generating the image data storage position URL described above, an image data storage unit 117 that stores the image data, and a transceiver 118 that transmits or receives various kinds of data via the communication line 4.

### Functional Configuration of Image Reading Apparatus 2

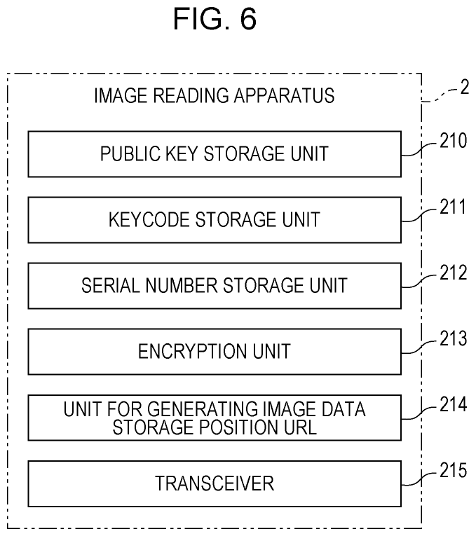

FIG. 6 illustrates an example of the functional configuration of the image reading apparatus 2. The processor 21 of the image reading apparatus 2 runs a program that is stored in the memory 22 to function as a public key storage unit 210 that stores the public key, a keycode storage unit 211 that stores the keycode, a serial number storage unit 212 that stores the serial number that is assigned to the image reading apparatus 2 for identification of the image reading apparatus, an encryption unit 213 for encryption with the public key described above, a unit 214 for generating the image data storage position URL described above, and a transceiver 215 that transmits or receives various kinds of data via the communication line 4. The unit 116 for generating the image data storage position URL in the server apparatus 1 and the unit 214 for generating the image data storage position URL in the image reading apparatus 2 generate the image data storage position URL in accordance with the same algorithm.

### Operation

### Initial Setting Operation

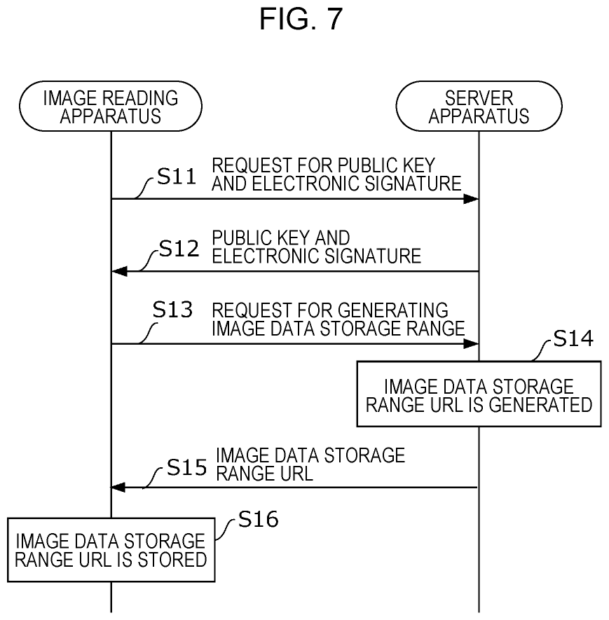

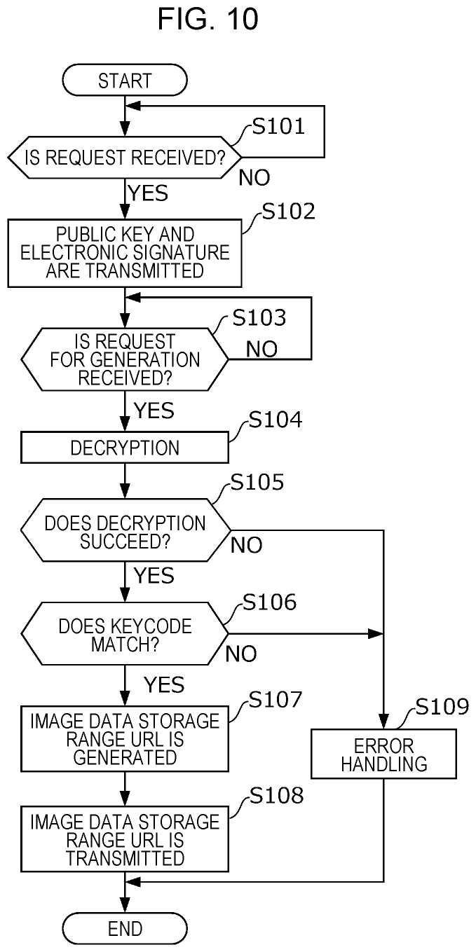

The operation of the information processing system 9 will be described with reference to FIG. 7 to FIG. 11. For example, processing illustrated by way of example in FIG. 7 is performed in the case where a predetermined condition is satisfied, for example, the image reading apparatus 2 is newly installed, or the settings of the image reading apparatus 2 are reset. At this time, the processor 11 of the server apparatus 1 performs processing illustrated by way of example in FIG. 10. The server apparatus 1 and the image reading apparatus 2 that are associated with each other store the common keycode before the processing in FIG. 7 and FIG. 10 is performed. Specifically, when the server apparatus 1 and the image reading apparatus 2 that are associated with each other are products manufactured by the same manufacturer, the common keycode is stored when the apparatuses are manufactured in a factory or are shipped. When the server apparatus 1 and the image reading apparatus 2 that are associated with each other belong to a common organization such as a place of business or an office, the apparatuses store the common keycode, for example, through an input from an administrator of the organization.

The processor 21 of the image reading apparatus 2 first requests the public key and an electronic signature from the server apparatus 1 (step S11 in FIG. 7). The processor 11 of the server apparatus 1 receives the request from the image reading apparatus 2 via the interface 13 (step S101 in FIG. 10) and transmits the public key and the electronic signature to the image reading apparatus 2 (step S12 in FIG. 7 and step S102 in FIG. 10). The processor 21 of the image reading apparatus 2 checks authenticity of the public key by using the electronic signature and stores this in the memory 22.

Subsequently, the processor 21 of the image reading apparatus 2 requests the server apparatus 1 to generate a range in which the image data that is transmitted from the image reading apparatus 2 is to be stored (step S13 in FIG. 7). The request for generating the image data storage range is made in a manner in which the keycode and the serial number (for example, aaa) that are stored in the memory 22, and the form of the request for generation (including, for example, attribution information about the image data storage range, such as the size or validity period of the image data storage range) are encrypted by using the public key described above.

The processor 11 of the server apparatus 1 receives the request for generating the image data storage range from the image reading apparatus 2 via the interface 13 (step S103 in FIG. 10) and decrypts this by using the private key (step S104 in FIG. 10). If the decryption succeeds (YES at step S105 in FIG. 10), authentication is performed by determining whether the decrypted keycode matches the keycode that is stored in the memory 12 (YES at step S106 in FIG. 10), and the image data storage range URL is subsequently generated (step S14 in FIG. 7 and step S107 in FIG. 10). The processor 11 of the server apparatus 1 transmits the generated image data storage range URL to the image reading apparatus 2 (step S15 in FIG. 7 and step S108 in FIG. 10). The processor 21 of the image reading apparatus 2 stores the received image data storage range URL (for example, www.xxx.com/yyy/aaa) in the memory 22 (step S16 in FIG. 7). If the results at steps S105 and S106 in FIG. 10 are negative, predetermined error handling is performed (step S109 in FIG. 10).

### Image Data Storage Operation

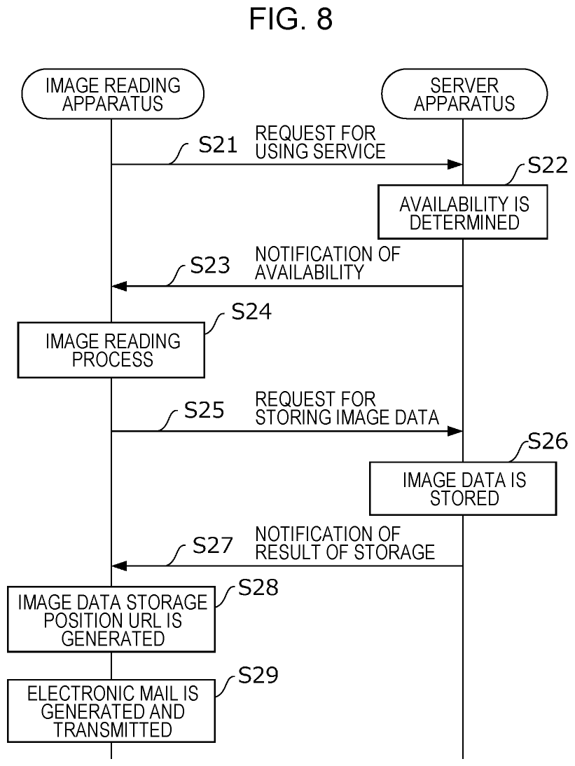

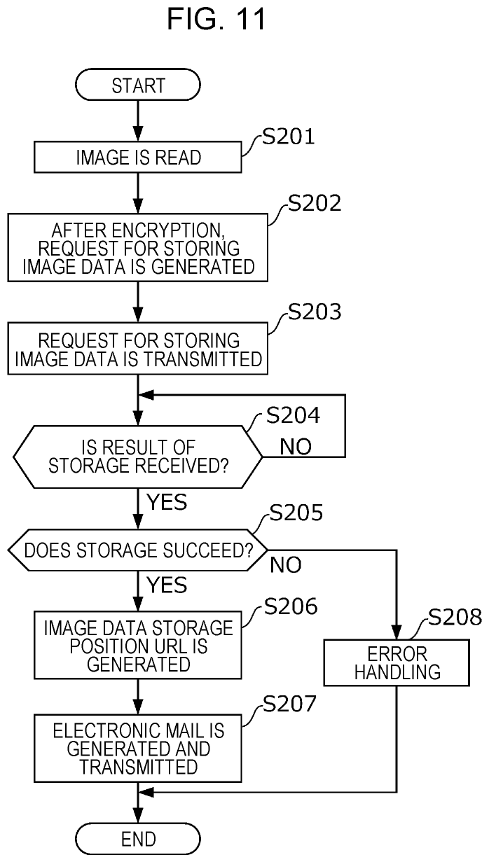

Subsequently, in the case where the image reading apparatus 2 is instructed to read an image, processing illustrated by way of example in FIG. 8 is performed. At this time, the processor 21 of the image reading apparatus 2 performs processing illustrated by way of example in FIG. 11.

The image reading apparatus 2 is first instructed to read the image by a user, and the processor 21 of the image reading apparatus 2 transmits a request for using a service to the server apparatus 1 (step S21 in FIG. 8). When image reading is instructed by the user, a mail address that represents the destination to which the image data storage position URL is transmitted is designated by the user or automatically after user authentication. The request for using the service is made in a manner in which the keycode and the serial number (for example, aaa) that are stored in the memory 22, and the form of a request for determining availability (the image data storage range URL (for example, www.xxx.com/yyy/aaa)) are encrypted by using the public key described above.

The processor 11 of the server apparatus 1 receives the request for using the service from the image reading apparatus 2 via the interface 13 and decrypts this by using the private key to determine the availability (step S22 in FIG. 8). The determination is made by determining whether the decrypted keycode matches the keycode that is stored in the memory 12 and by determining whether there is an image data storage range related to the form of the request for determining the availability and the decrypted serial number. The processor 11 of the server apparatus 1 transmits an availability notification including the result of the determination of the availability to the image reading apparatus 2 (step S23 in FIG. 8). When the received availability notification represents being available, the processor 21 of the image reading apparatus 2 reads a document that is set by the user and generates the image data (step S24 in FIG. 8 and step S201 in FIG. 11).

Subsequently, the processor 21 of the image reading apparatus 2 transmits a request for storing the image data to the server apparatus 1 (step S25 in FIG. 8 and steps S202 and S203 in FIG. 11). The request for storing the image data is made in a manner in which the keycode and the serial number (for example, aaa) that are stored in the memory 22, the generated image data, a random character string (for example, jksaroie585) that is generated by the algorithm for generating a URL, and the form of the request for storing the image data are encrypted by using the public key described above.

The processor 11 of the server apparatus 1 receives the request for storing the image data from the image reading apparatus 2 via the interface 13, decrypts this by using the private key, and determines whether the image data is allowed to be stored. The determination is made by determining whether the decrypted keycode matches the keycode that is stored in the memory 12 and by determining whether there is an image data storage range related to the decrypted serial number. That is, if the decrypted keycode matches the keycode that is stored in the memory 12, and there is the image data storage range related to the decrypted serial number, the processor 11 of the server apparatus 1 determines that the image data is allowed to be stored. In the case where the image data is allowed to be stored, the processor 11 of the server apparatus 1 stores the image data in the memory 12 at a position at which the image data is accessible by using the image data storage position URL (for example, www.xxx.com/yyy/aaa/jksaroie585) including the decrypted random character string (for example, jksaroie585) at the end of the image data storage range (for example, www.xxx.com/yyy/aaa) related to the decrypted serial number (step S26 in FIG. 8). The processor 11 of the server apparatus 1 stores the image data and subsequently transmits the result of the storage to the image reading apparatus 2 (step S27 in FIG. 8).

In the case where the result of the storage is received (step S204 in FIG. 11) and the image data is successfully stored (YES at step S205 in FIG. 11), the processor 21 of the image reading apparatus 2 generates an electronic mail on which is written the image data storage position URL (for example, www.xxx.com/yyy/aaa/jksaroie585) including the random character string (for example, jksaroie585) that is generated by the algorithm for generating a URL at the end of the image data storage range URL (for example, www.xxx.com/yyy/aaa) that is stored at step S16 in FIG. 7 (step S28 in FIG. 8 and step S206 in FIG. 11). The processor 21 of the image reading apparatus 2 transmits the electronic mail to the user terminal 3 having the mail address that is designated when image reading is instructed by the user (step S29 in FIG. 8 and step S207 in FIG. 11). If the result at steps S205 in FIG. 11 is negative, predetermined error handling is performed (step S208 in FIG. 11).

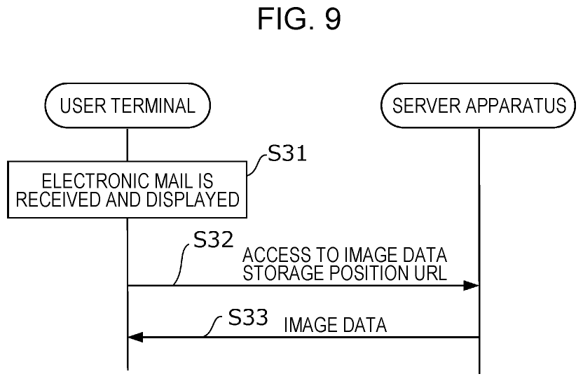

In FIG. 9, the processor of the user terminal 3 causes the received electronic mail to be displayed (step S31 in FIG. 9), accesses the URL when the user designates the image data storage position URL (step S32), and acquires the image data from the server apparatus 1 (step S33).

With the configurations described above, the server apparatus 1 stores the image data after the server apparatus 1 and the image reading apparatus 2 perform the authentication by using the keycode.

### Modifications

The exemplary embodiment is described above. The content of the exemplary embodiment, however, may be modified as described below. Modifications described below may be combined with each other.

### First Modification

The server apparatus 1 according to the exemplary embodiment described above includes the processor 11 that includes the CPU. However, a controller that controls the server apparatus 1 may have a different structure. For example, the server apparatus 1 may include various processors other than the CPU.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

### Second Modification

In the embodiments above, the term “processor” is broad enough to encompass one processor or plural processors in collaboration which are located physically apart from each other but may work cooperatively. The order of operations of the processor is not limited to one described in the embodiments above, and may be changed.

### Third Modification

According to the exemplary embodiment described above, the processor 21 of the image reading apparatus 2 writes the image data storage position URL on the electronic mail and transmits the image data storage position URL to the user terminal 3. In addition to the image data storage position URL, a URL containing a character string that designates a process (for example, deletion of the image data) to be performed on the image data may also be written on the electronic mail and may be transmitted to the user terminal 3. When, for example, the image data is used by a single user terminal 3 and the user who uses the image data deletes the used image data, the processor 11 of the server apparatus 1 deletes the stored image data in response to access to the URL described above. The processor 21 of the image reading apparatus 2 may thus transmit, to the user terminal 3, the storage position identifier including the character string that designates the process to be performed on the image data stored in the server apparatus 1.

### Fourth Modification

Electronic mails on which the image data storage position URLs are written may be transmitted to multiple user terminals 3 (that is, multiple mail addresses). In this case, the image data storage position URLs that are transmitted to the respective user terminals 3 differ from each other. That is, the image data storage position URLs different from each other for the multiple user terminals 3 are written on the respective electronic mails. The processor 11 of the server apparatus 1 may determine which user uses the image data by monitoring whether there is access to a corresponding image data storage position URL. That is, in the case where the image data storage position URLs are transmitted to the multiple user terminals 3, the processor 21 of the image reading apparatus 2 may transmit an electronic mail on which is written an image data storage position identifier including a terminal identifier (for example, the mail address) for identification of the user terminal 3 to which the electronic mail is transmitted.

### Fifth Modification

According to the exemplary embodiment described above, the server apparatus 1 and the image reading apparatus 2 that are associated with each other belong to the common organization as a premise. However, a business operator that provides an image data storage service, for example, may prepare the server apparatus 1 or a data storage region in the server apparatus 1 for every organization. That is, it suffices that the server apparatus 1 and the image reading apparatus 2 are associated with each other.

### Sixth Modification

The password may be set per image data. For example, the user may input a password into the image reading apparatus 2 when an image is read, the image reading apparatus 2 may notify the server apparatus 1 of the password, the user may input a password into the user terminal 3 when the image data is used, the user terminal 3 may notify the server apparatus 1 of the password, and the processor 11 of the server apparatus 1 may compare the passwords and may determine that the image data is usable if the passwords match.

### Seventh Modification

The image data that is stored in the server apparatus 1 may be deleted by the processor 11 after a predetermined time has passed.

### Eighth Modification

As for communications via the communication line, a measure against data leakage may be taken, for example, by using S/MIME encryption or by using a SSL communication.

### Ninth Modification

A program that is run by the processor 11 of the server apparatus 1 according to the exemplary embodiment described above corresponds to an example of a program causing a computer that includes a processor to execute a process including storing the storage range identifier for identification of a range of a location at which image data is stored in the data storing apparatus that stores the image data transmitted from the processor, and the identifier common to the identifier that is retained by the data storing apparatus, transmitting the read image data and the identifier to the data storing apparatus, generating the storage position identifier for identification of the position at which the read image data is stored, by using the storage range identifier and the character string that is generated by the algorithm common to that in the data storing apparatus, and transmitting the generated storage position identifier to the terminal that uses the image data stored at the position that is identified by using the storage position identifier. The program may be provided as the program stored in a computer readable storage medium, for example, a magnetic storage medium such as a magnetic tape or a magnetic disk, an optical storage medium such as an optical disk, a magneto-optical storage medium, or a semiconductor memory. The program may be downloaded via a communication line such as the Internet.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
store a storage range identifier for identification of a range of a location at which image data is stored in a data storing apparatus, and an identifier common to an identifier that is retained by the data storing apparatus,
transmit read image data and the identifier to the data storing apparatus,
generate a storage position identifier for identification of a position at which the read image data is stored, the storage position identifier being generated by using the storage range identifier and a character string that is generated by an algorithm common to an algorithm in the data storing apparatus, and
transmit the generated storage position identifier to a terminal that uses the image data stored at the position that is identified by using the storage position identifier.

2. The information processing apparatus according to claim 1, wherein the processor is configured to
transmit the stored identifier to the data storing apparatus, and
store the storage range identifier that is transmitted from the data storing apparatus after the data storing apparatus performs authentication by using the transmitted identifier.

3. The information processing apparatus according to claim 1, wherein the processor is configured to store the storage range identifier including an apparatus identifier for identification of the information processing apparatus.

4. The information processing apparatus according to claim 2, wherein the processor is configured to store the storage range identifier including an apparatus identifier for identification of the information processing apparatus.

5. The information processing apparatus according to claim 1, wherein the processor is configured to transmit the storage position identifier including the character string and an apparatus identifier for identification of the information processing apparatus.

6. The information processing apparatus according to claim 2, wherein the processor is configured to transmit the storage position identifier including the character string and an apparatus identifier for identification of the information processing apparatus.

7. The information processing apparatus according to claim 3, wherein the processor is configured to transmit the storage position identifier including the character string and the apparatus identifier for identification of the information processing apparatus.

8. The information processing apparatus according to claim 4, wherein the processor is configured to transmit the storage position identifier including the character string and the apparatus identifier for identification of the information processing apparatus.

9. The information processing apparatus according to claim 1, wherein the processor is configured to
encrypt data by using a public key associated with the data storing apparatus, and
transmit the encrypted data to the data storing apparatus.

10. The information processing apparatus according to claim 2, wherein the processor is configured to
encrypt data by using a public key associated with the data storing apparatus, and
transmit the encrypted data to the data storing apparatus.

11. The information processing apparatus according to claim 3, wherein the processor is configured to
encrypt data by using a public key associated with the data storing apparatus, and
transmit the encrypted data to the data storing apparatus.

12. The information processing apparatus according to claim 4, wherein the processor is configured to
encrypt data by using a public key associated with the data storing apparatus, and
transmit the encrypted data to the data storing apparatus.

13. The information processing apparatus according to claim 5, wherein the processor is configured to
encrypt data by using a public key associated with the data storing apparatus, and
transmit the encrypted data to the data storing apparatus.

14. The information processing apparatus according to claim 6, wherein the processor is configured to
encrypt data by using a public key associated with the data storing apparatus, and
transmit the encrypted data to the data storing apparatus.

15. The information processing apparatus according to claim 7, wherein the processor is configured to
encrypt data by using a public key associated with the data storing apparatus, and
transmit the encrypted data to the data storing apparatus.

16. The information processing apparatus according to claim 8, wherein the processor is configured to
encrypt data by using a public key associated with the data storing apparatus, and
transmit the encrypted data to the data storing apparatus.

17. The information processing apparatus according to claim 1, wherein the processor is configured to transmit, to the terminal, the storage position identifier including a character string that designates a process to be performed on the image data stored in the data storing apparatus.

18. The information processing apparatus according to claim 1, wherein the storage position identifier is transmitted to a plurality of the terminals, and the processor is configured to transmit the storage position identifier including a terminal identifier for identification of a corresponding terminal to which the storage position identifier is transmitted.

19. A non-transitory computer readable medium storing a program causing a computer to execute a process, the process comprising:
storing a storage range identifier for identification of a range of a location at which image data is stored in a data storing apparatus, and an identifier common to an identifier that is retained by the data storing apparatus;
transmitting read image data and the identifier to the data storing apparatus;
generating a storage position identifier for identification of a position at which the read image data is stored, the storage position identifier being generated by using the storage range identifier and a character string that is generated by an algorithm common to an algorithm in the data storing apparatus; and
transmitting the generated storage position identifier to a terminal that uses the image data stored at the position that is identified by using the storage position identifier.

20. An information processing system comprising:
an image reading apparatus; and
a data storing apparatus,
wherein the image reading apparatus includes a processor configured to
store a storage range identifier for identification of a range of a location at which image data is stored in a data storing apparatus, and an identifier common to an identifier that is retained by the data storing apparatus,
transmit read image data and the identifier to the data storing apparatus,
generate a storage position identifier for identification of a position at which the read image data is stored, the storage position identifier being generated by using the storage range identifier and a character string that is generated by an algorithm common to an algorithm in the data storing apparatus, and
transmit the generated storage position identifier to a terminal that uses the image data stored at the position that is identified by using the storage position identifier and,
wherein the data storing apparatus includes a processor configured to
transmit, to the image reading apparatus, the storage range identifier for identification of the range of the location at which is stored the image data that is transmitted from the image reading apparatus,
acquire the image data and the identifier from the image reading apparatus,
generate the storage position identifier by using the storage range identifier and the character string that is generated by the algorithm common to the algorithm in the image reading apparatus, and
store the image data at the position that is identified by using the generated storage position identifier.
